(19) United States
(12) Patent Application Publication
(10) Pub. No.: US 2012/0316061 A1
(43) Pub. Date: Dec. 13, 2012

(54) FUEL CELL ELECTROCATALYST

(76) Inventors: Tetsuo Nagami, Nagoya-shi (JP); Isotta Cerri, Steenokkerzeel (BE); Claire Mormiche, Hampshire (GB); Jonathan Conrad Davies, Hampshire (GB); Brian Elliott Hayden, Hampshire (GB)

(21) Appl. No.: 12/998,118

(22) PCT Filed: Mar. 5, 2010
(86) PCT No.: PCT/JP10/54164

§ 371 Date: Mar. 18, 2011

(51) Int. Cl. B01J 23/644; B01J 23/18

(52) U.S. Cl. 502/339; 502/352

(57) ABSTRACT

This invention provides a highly stable electrocatalyst having excellent electrochemical properties, which comprises a support containing a composite oxide containing Sb-doped SnO₂ and a catalyst supported by the support, wherein the composite oxide is an amorphous composite oxide and the percentage of Sb with respect to the sum of Sb and Sn in the composite oxide is 2 to 10 at. %, or wherein the composite oxide is a crystalline composite oxide and the percentage of Sb with respect to the sum of Sb and Sn in the composite oxide is 1 to 3 at. %.

### TECHNICAL FIELD

The present invention relates to an electrocatalyst used for fuel cells.

### BACKGROUND ART

Fuel cells generate electric power by the electrochemical reaction of hydrogen and oxygen. In principle, only water is produced as a result of power generation. Therefore, fuel cells have been gaining attention as clean power generation systems that substantially cause no environmental burdens.

For instance, fuel cells can be classified into the following types depending on the type of electrolyte: polymer electrolyte fuel cells (PEFCs); phosphoric acid fuel cells (PAFCs); molten carbonate fuel cells (MCFCs); and solid oxide fuel cells (SOFCs). Of these, PEFCs and PAFCs generally contain catalyst-supporting porous carbon as an electrocatalyst.

As described above, if carbon is used as a material for fuel cell electrocatalysts, a reaction that oxidizes carbon to CO₂ proceeds as a result of an electrochemical reaction between carbon and water contained in an electrolyte. Such reaction proceeds at a potential of 0.2 V (SHE basis) or higher based on equilibrium theory. It has been known that the reaction rate is accelerated as the potential increases.

Therefore, the above reaction gradually proceeds in a cathode electrode in a usual environment for using fuel cells (0.3-0.9 V). In addition, a potential of 1 V or higher may be generated in a cathode electrode at the time of startup/stop. Under such conditions, the above reaction proceeds at a significantly accelerated rate. As a result, “thinning” of an electrocatalyst might be observed in fuel cells that have been used for long time due to reduction of carbon in a cathode electrode. If “thinning” of an electrocatalyst occurs, fuel cell performance significantly deteriorates.

At present, there is no definitive means for solving the above problems. Under such circumstances, the occurrence of thinning of an electrocatalyst is prevented mainly with the use of both hardware (emission valve) and software (control). Accordingly, it has been necessary to develop a novel electrocatalyst material that can replace carbon.

Patent Document 1 discloses a catalyst electrode material comprising a support material mainly consisting of an oxide and supporting a catalyst material. The document describes the following oxides: titanium oxide, vanadium oxide, tantalum oxide, tungsten oxide, antimony oxide, molybdenum oxide, tin oxide, erbium oxide, cerium oxide, zirconium oxide, silicon oxide, zinc oxide, magnesium oxide, niobium oxide, and aluminium oxide.

Patent Document 2 discloses a support catalyst for fuel cells comprising: an oxide support; catalyst particles supported on the surface of the oxide support; a catalyst layer containing an oxide or a composite oxide containing at least one member selected from the group consisting of Mo, W, Sn, and Ru, thereby having a melting point of less than 1500° C., which is located between each two catalyst particles on the surface of the oxide support; and an interface shared by the oxide support, the catalyst particles, and the catalyst layer. The document describes the following oxides used for oxide supports: TiO₂, ZrO₂, SnO₂, WO₃, Al₂O₃, Cr₂O₃, Nb₂O₅, and SiO₂.

Patent Document 3 discloses a fuel cell electrode comprising: a catalyst support comprising at least one member selected from the group consisting of Sn-doped In₂O₃, F-doped SnO₂, and Sb-doped SnO₂; a proton conductive inorganic oxide comprising an oxide particle layer containing at least one element selected from the group consisting of W, Mo, Cr, V, and B, which is chemically bound to the surface of the catalyst support; a catalyst composite comprising an oxidation reduction catalyst layer, which is supported directly or via the oxide particle layer by the catalyst support; and a catalyst layer containing a binder.
Patent Document 1: JP Patent Publication (Kokai) No. 2006-210135 A
Patent Document 2: JP Patent Publication (Kokai) No. 2007-5136 A
Patent Document 3: JP Patent Publication (Kokai) No. 2008-34300 A

### DISCLOSURE OF THE INVENTION

Patent Documents 1 to 3 describe the use of tin oxide (SnO₂) as a metal oxide. SnO₂ can be used as an oxide semiconductor which shows electron conductivity by itself under certain conditions. However, when SnO₂ is used for such as electrocatalyst support materials, it is necessary to dope SnO₂ with different minor components in order to improve electron conductivity. For instance, Patent Document 1 describes that the addition of small amounts of a carbon material as a conduction adjuvant. In such case, the aforementioned oxidation reaction can proceed in the presence of the added carbon material, which is problematic in terms of durability. In addition, Patent Document 3 discloses a catalyst support containing antimony (Sb)-doped SnO₂. In the case of the electrode disclosed in the document, the surface of a catalyst support is completely or partially covered with an inorganic oxide having proton conductivity. As a result, it is difficult to improve the electron conductivity of the electrode.

As described above, some techniques have been suggested that involve using a metal oxide or composite oxide as a support for a fuel cell electrocatalyst. However, no electrocatalysts having sufficient durability and/or output properties have been developed. In order to develop a metal oxide or composite oxide appropriate for an electrocatalyst support, it is necessary to examine a variety of combinations in terms of such as metal types and dopant contents. Therefore, it is an object of the present invention to provide an electrocatalyst having properties appropriate for fuel cells by screening for the optimum content of Sb in an electrocatalyst containing Sb-doped SnO₂ with the use of a library created by combinatorial chemistry array technology.

As a result of examination of various means for achieving the above object, the present inventors have found that a highly stable electrocatalyst having excellent electrochemical properties can be obtained with the use of a crystalline or amorphous composite oxide comprising Sb-doped SnO₂ as a support for the electrocatalyst. This has led to the completion of the present invention.

Specifically, the present invention is described in summary as follows.

(1) An electrocatalyst, comprising a support containing an amorphous composite oxide containing Sb-doped SnO₂ and a catalyst supported by the support, wherein the percentage of Sb with respect to the sum of Sb and Sn in the composite oxide is 2 to 10 at. %.

(2) An electrocatalyst, comprising a support containing a crystalline composite oxide containing Sb-doped SnO₂ and a catalyst supported by the support, wherein the percentage of Sb with respect to the sum of Sb and Sn in the composite oxide is 1 to 3 at. %.

(3) The electrocatalyst according to (1) or (2), wherein the catalyst is Pt.

The present invention makes it possible to obtain a highly stable electrocatalyst having excellent electrochemical properties.

### BRIEF DESCRIPTION OF DRAWINGS

FIG. 1 is a chart showing XRD patterns of the composite oxide films of the present invention subjected to annealing at 500° C. for 6 hours.

FIG. 2 is a chart showing the electroresistivity of each amorphous composite oxide film measured by the four point probe conductivity measurement method.

FIG. 3 is a chart showing the electroresistivity of each crystalline composite oxide film measured by the four point probe conductivity measurement method.

FIG. 4 is a chart showing film thickness loss (%) of amorphous composite oxide films subjected to acid treatment.

FIG. 5 is a transmission electron microscope (TEM) image showing Pt particles supported on a carbon support film.

FIG. 6 is a chart showing the oxygen reduction activity of each electrocatalyst having Pt particles supported thereon that is formed with an amorphous combinatorial chemistry array electrode.

FIG. 7 is a chart showing the oxygen reduction onset potential for each electrocatalyst having Pt particles supported thereon that is formed with an amorphous combinatorial chemistry array electrode.

FIG. 8 is a chart showing the stability of each electrocatalyst having Pt particles supported thereon that is formed with an amorphous combinatorial chemistry array electrode.

FIG. 9 is a chart showing cyclic voltammograms of crystalline electrocatalysts having Pt particles supported thereon.

FIG. 10 is a chart showing oxygen reduction onset potentials (corresponding to the relevant amounts of added Sb) determined based on cyclic voltammograms in FIG. 9.

FIG. 11 is a chart showing the relationship between the annealing temperature for preparing an electrocatalyst and the electrocatalyst oxygen reduction activity.

### DESCRIPTION OF EMBODIMENTS

The preferred embodiments of the present invention are hereinafter described in greater detail.

### 1. Composite Oxide

The term “composite oxide” used herein refers to a compound formed by doping tin oxide (SnO₂) with antimony (Sb). When SnO₂ is doped with Sb, the Sn⁴⁺ site in the SnO₂ crystal is substituted with Sb⁵⁺. The site substituted with Sb⁵⁺ is in a state in which it lacks a single electron due to loss of charge balance. Such site lacking an electron serves as an electron-conducting path, and thus the composite oxide of the present invention shows conductivity.

The crystalline structure of the composite oxide of the present invention may be in an amorphous or crystalline form. A method for producing such a composite oxide is described in detail below.

Since a crystalline composite oxide shows higher oxidation reduction onset potential than an amorphous composite oxide, a crystalline composite oxide is preferably used as a support to be contained in electrocatalyst. In addition, a composite oxide subjected to heat treatment at a higher annealing temperature has increased crystalline properties, thereby showing higher oxidation reduction onset potentials. Therefore, such composite is preferably used as a support to be contained in electrocatalyst. In such case, a composite oxide is heat-treated at an annealing temperature of 500° C. to 800° C. such that a highly crystalline composite oxide can be obtained. Further, the term “support” used herein refers to a material for an electrocatalyst that supports a catalyst containing the aforementioned amorphous or crystalline composite oxide.

An electrocatalyst having excellent electrochemical properties can be obtained with the use of a composite oxide having the above crystalline structure as a support.

In addition, the crystalline structure of the composite oxide and the state of crystalline form can be confirmed by, for example but not limited to, measuring X-ray diffraction (XRD) spectra.

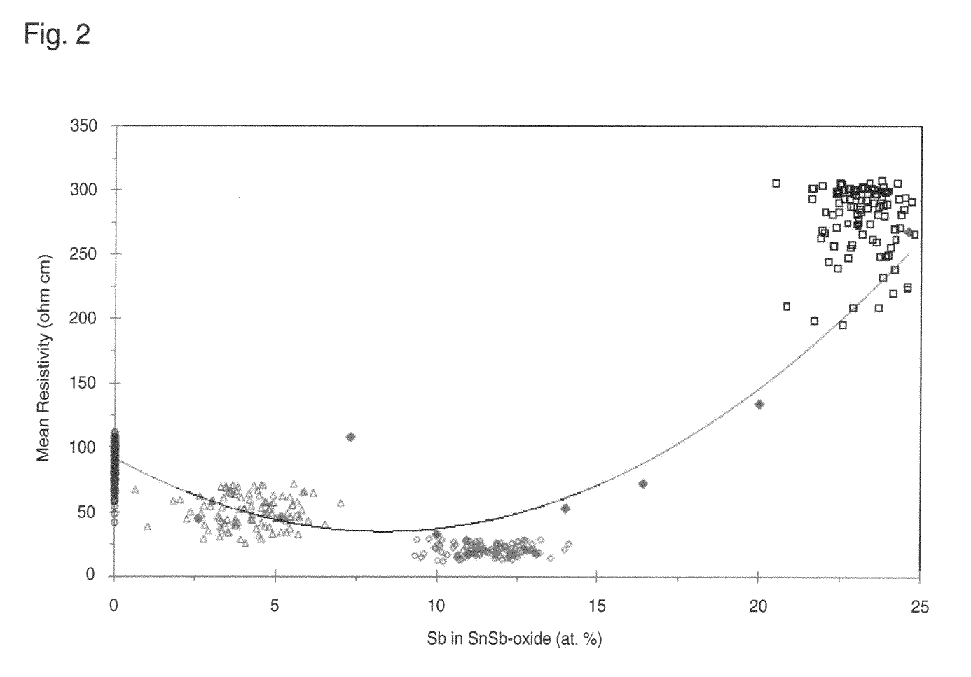

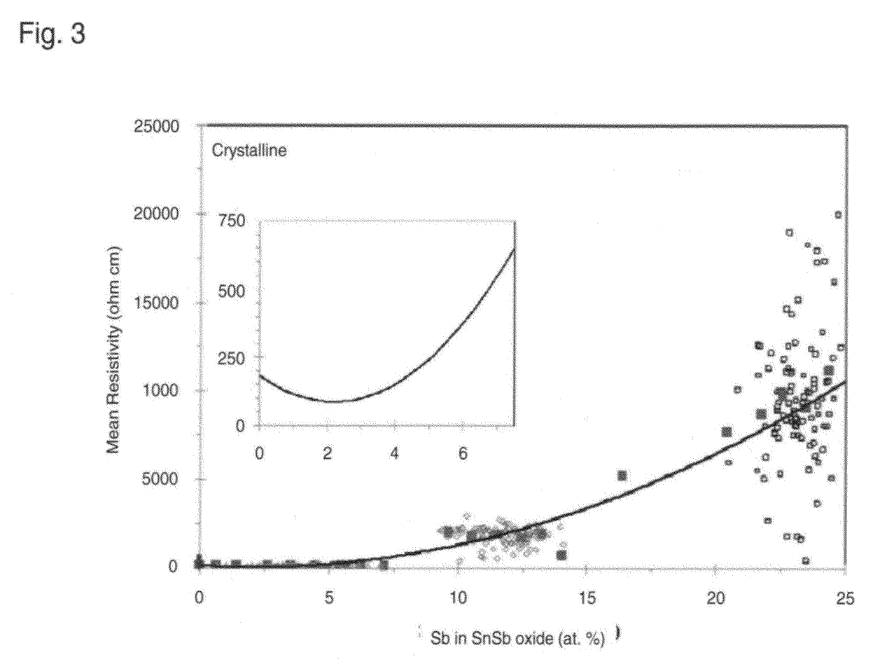

In the case of the composite oxide comprising Sb-doped SnO₂ of the present invention, a secondary correlation between the amount of added Sb (doping on SnO₂) and the resistivity of the resulting composite oxide is established with the minimum value (FIGS. 2 and 3). In addition, the amount of added SU at the minimum value would vary for both a crystalline composite oxide and an amorphous composite oxide. Probably, the reason why the amount of added Sb at the minimum value of resistivity would vary for each case is that some oxygen atoms contained in a composite oxide would be removed during heat treatment for crystallization, resulting in different oxygen stoichiometric ratios in both cases.

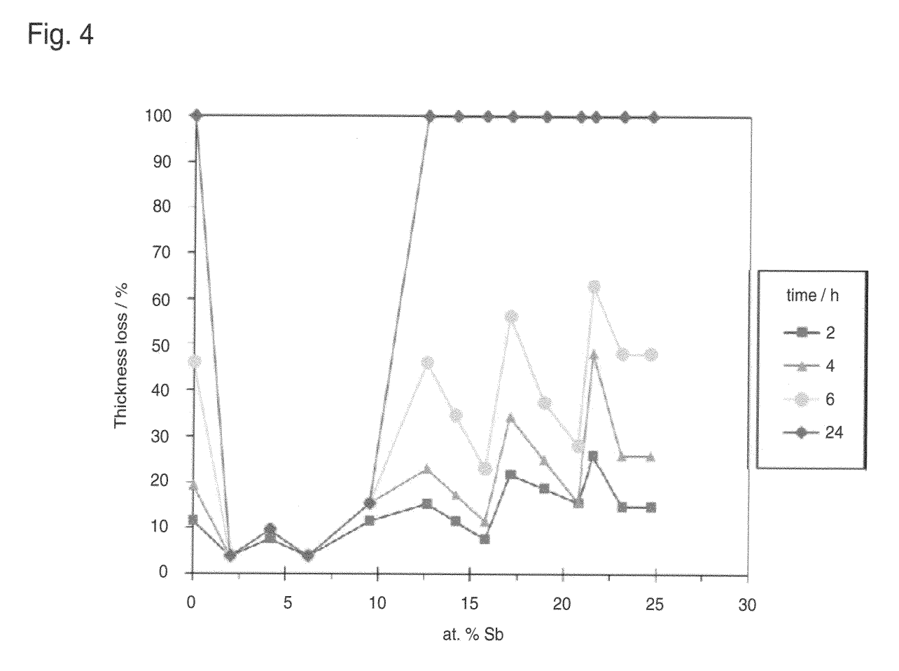

Further, when an amorphous composite oxide is doped with Sb at percentage of Sb of 2 to 10 at. % with respect to the sum of Sb and Sn, the acid resistance of the resulting composite oxide is improved (FIG. 4).

Therefore, in the case of an amorphous composite oxide, the percentage of Sb with respect to the sum of Sb and Sn is preferably 2 to 10 at. % and more preferably 8 to 10 at. %. In addition, in the case of a composite oxide having the crystalline structure of a crystal, the percentage of Sb with respect to the sum of Sb and Sn is preferably 1 to 3 at. %. A composite oxide having high acid resistance and high electroconductivity can be obtained by doping a composite oxide with Sb within the above percentage range.

In addition, the percentage (at. %) of Sb with respect to the sum of Sb and Sn in the composite oxide can be identified by, for example but not limited to, measuring energy dispersive X-ray spectrometry (EDX) spectra.

The composite oxide of the present invention may be in a film or powder form. In the case of the film form, the average film thickness is preferably 100 to 1000 nm. In addition, when the composite oxide is in the powder form, powder particles are preferably in spherical or approximately spherical forms, and the average particle size is preferably 10 to 50 nm.

An electrocatalyst with high strength and a large surface area can be produced with the use of a composite oxide film with a film thickness within the above range as a support for electrocatalysts. In addition, an electrocatalyst that can be readily bonded to an electrolyte and has a large surface area can be produced with the use of a composite oxide powder with a particle size within the above range as a support for electrocatalysts.

In addition, the average film thickness of a composite oxide can be measured by such as, but not limited to, a fluorescent X-ray film thickness meter or ellipsometry, and the average particle size thereof can be measured by such as, but not limited to, a transmission electron microscope (TEM) or a scanning electron microscope (SEM).

### 2. Electrocatalyst

The term “electrocatalyst” used herein refers to an electrode material having catalyst activity, which comprises the aforementioned support containing a composite oxide and a catalyst supported by the support.

An example of a catalyst used for the electrocatalyst of the present invention is a catalyst containing platinum (Pt) or a platinum alloy comprising Pt and noble metals other than Pt (and/or a transition metal). Herein, examples of a noble metal other than Pt include ruthenium (Ru), osmium (Os), rhodium (Rh), iridium (Ir), palladium (Pd), gold (Au), and silver (Ag). In addition, examples of transition metals include molybdenum (Mo), cobalt (Co), iron (Fe), nickel (Ni), titanium (Ti), tungsten (W), rhenium (Re), chromium (Cr), manganese (Mn), niobium (Nb), and tantalum (Ta). Preferably, a catalyst containing Pt is used.

An electrocatalyst comprising a support containing a composite oxide and a catalyst supported by the support can be obtained by the catalyst supporting step described below. In addition, the density of supported catalyst is defined in terms of the percent by weight (% by weight) of the catalyst supported with respect to the total weight of the electrocatalyst. Such density of a supported catalyst is calculated by the following calculation formula when a catalyst is Pt: the Pt weight/(the Pt weight+the composite oxide weight)×100. In addition, when the catalyst is a platinum alloy, the same is calculated by the following calculation formula: (the Pt weight+the weight of a noble metal other than Pt+the transition metal weight)/(the Pt weight+the weight of a noble metal other than Pt+the transition metal weight+the composite oxide weight)×100. The density of the supported catalyst is preferably 1% to 50% by weight in the electrocatalyst of the present invention. In addition, the weight of Pt supported by an electrocatalyst, the weight of a noble metal other than Pt, the transition metal weight, and the composite oxide weight can be measured by treating the electrocatalyst with acid or the like so as to dissolve Pt, a noble metal other than Pt, a transition metal, and a composite oxide, and quantifying metal components in the resulting solution by ICP or the like.

When a platinum alloy is used for a catalyst, the composition is defined in terms of the percent by weight (% by weight) of Pt, a noble metal other than Pt, or a transition metal with respect to the total weight of a platinum alloy supported. Such composition is calculated by the following calculation formula: the Pt weight/(the Pt weight+the weight of a noble metal other than Pt+the transition metal weight)×100; the weight of a noble metal other than Pt/(the Pt weight+the weight of a noble metal other than Pt+the transition metal weight)×100; or the transition metal weight/(the Pt weight+the weight of a noble metal other than Pt+the transition metal weight)×100. Preferably, in the composition of a platinum alloy in the electrocatalyst of the present invention, a noble metal other than Pt or a transition metal is contained at preferably 5% to 50% by weight when Pt is contained at 50% to 95% by weight. In addition, the Pt weight, the weight of a noble metal other than Pt, the transition metal weight, and the composite oxide weight can be calculated by the above method.

Preferably, the catalyst is in a spherical or approximately spherical form. In such case, the average particle size is preferably 1 to 10 nm. In addition, the average particle size can be calculated based on the crystallite size measured by XRD.

An electrocatalyst having high catalyst activity can be obtained with the use of the above catalyst.

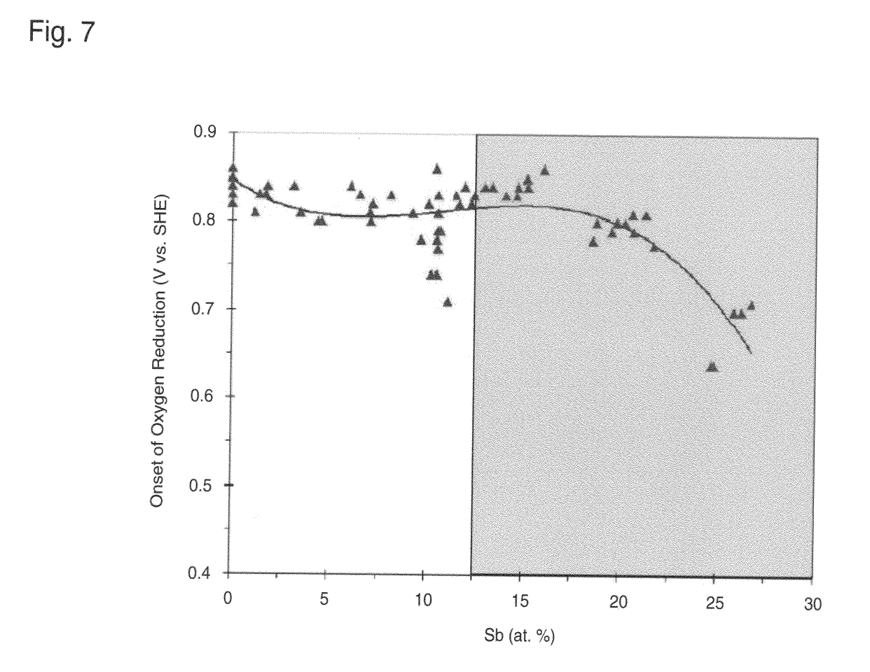

In the case of an electrocatalyst comprising a support containing an amorphous composite oxide and the catalyst supported by the support, if a composite oxide with a percentage of Sb of 0 to 20 at. % with respect to the sum of Sb and Sn is used, the electrocatalyst shows high oxygen reduction onset potentials (FIG. 7). Note that, as described above, when the percentage of Sb with respect to the sum of Sb and Sn in the composite oxide is 12.5 at. % or more, the acid resistance of the composite oxide significantly decreases, which is not preferable (FIG. 4). Therefore, in the case of an electrocatalyst comprising a support containing an amorphous composite oxide and the catalyst supported by the support, the percentage of Sb with respect to the sum of Sb and Sn in the composite oxide is preferably 0 to 20 at. % and more preferably 0 to 10 at. %. An electrocatalyst having excellent electrochemical properties can be obtained using a support containing a composite oxide that has been doped with Sb within the above percentage range for an electrocatalyst.

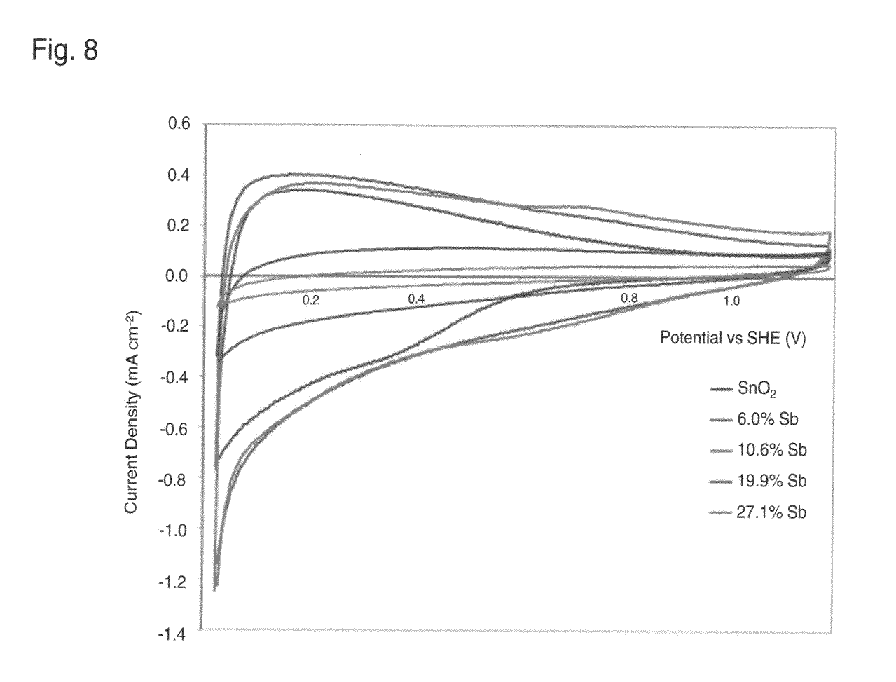

Meanwhile, in a case in which the above electrocatalyst is subjected to treatment by applying potential cycles thereto, following which changes in oxygen reduction properties are determined, if an electrocatalyst contains a composite oxide having a higher percentage of Sb with respect to the sum of Sb and Sn, the current density becomes lower after treatment (FIG. 8). It is thought that this phenomenon is caused by occurrence of dissolution of a composite oxide due to application of potential cycles. The above treatment of applying potential cycles is a simulated treatment in order to evaluate influence on fuel cells during long-term operation. In such case, the stability of electrocatalyst is evaluated based on changes in oxygen reduction properties such as current density. That is to say, if an electrocatalyst experiences fewer changes in oxygen reduction properties, it can be regarded as an electrocatalyst with excellent stability. Therefore, in the case of an electrocatalyst comprising a support containing an amorphous composite oxide and the catalyst supported by the support, a highly stable electrocatalyst can be obtained using a composite oxide containing Sb at 0 to 10 at. % with respect to the sum of Sb and Sn for the electrocatalyst.

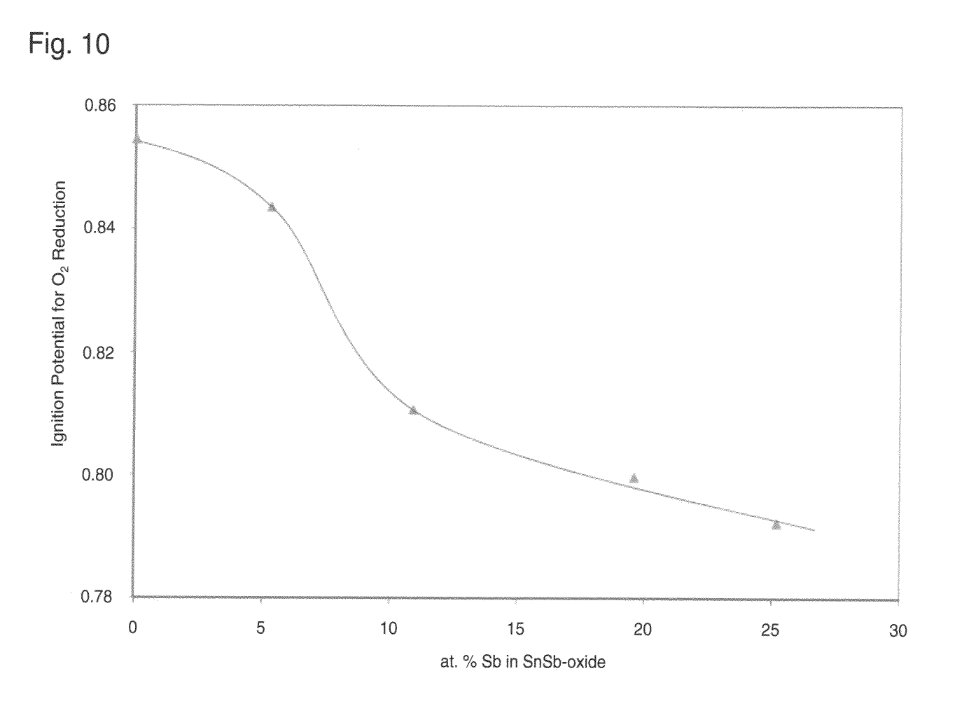

In the case of an electrocatalyst comprising a support containing a crystalline composite oxide and the catalyst supported by the support, if a composite oxide containing Sb at 0 to 5 at. % with respect to the sum of Sb and Sn is used, the electrocatalyst shows high oxygen reduction onset potentials (FIG. 10). Therefore, in the case of an electrocatalyst comprising a support containing a crystalline composite oxide and the catalyst supported by the support, the percentage of Sb with respect to the sum of Sb and Sn in the composite oxide is preferably 0 to 5 at. %. An electrocatalyst having excellent electrochemical properties can be obtained using a support containing a composite oxide that has been doped with Sb within the above percentage range for an electrocatalyst.

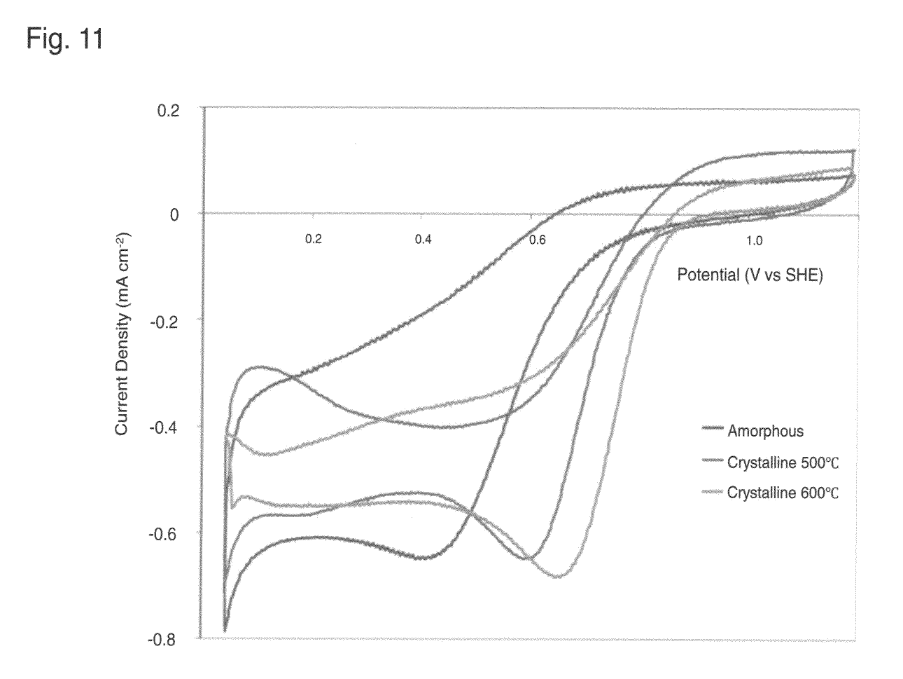

In addition, in the case of an electrocatalyst comprising a support containing a crystalline composite oxide and the catalyst supported by the support, as the annealing temperature of heat treatment for crystallization of a composite oxide increases, the oxygen reduction onset potential of the resulting electrocatalyst can be improved (FIG. 11). Therefore, the annealing temperature is preferably 500° C. to 800° C. An electrocatalyst having excellent electrochemical properties can be obtained by crystallizing a composite oxide under the above conditions so as to use the crystallized composite oxide for the electrocatalyst.

As described above, a highly stable electrocatalyst having excellent electrochemical properties can be obtained using a composite oxide with the above composition as a support for an electrocatalyst. Therefore, fuel cells that exhibit stable power generation performance for long time can be obtained using such electrocatalyst as a fuel cell electrocatalyst.

### 3. Method for Production of Electrocatalyst

When the electrocatalyst of the present invention is in a film form and contains an amorphous composite oxide as a support, the electrocatalyst can be produced by a method comprising: a synthesis step of doping SnO₂ with Sb so as to synthesize an amorphous composite oxide; and a catalyst supporting step of allowing the composite oxide to support a) catalyst.

In addition, when the electrocatalyst of the present invention is in a film form and contains a crystalline composite oxide as a support, the electrocatalyst can be produced by a method comprising: a synthesis step of doping SnO₂ with Sb so as to synthesize an amorphous composite oxide; a crystallization step of heat-treating the amorphous composite oxide to cause crystallization thereof; and a catalyst supporting step of allowing the composite oxide to support a catalyst.

Each step is described below.

### 3-1. Synthesis Step

It has been known that a composite oxide comprising Sb-doped SnO₂ can be synthesized by different methods. The synthesis method used in this step is not particularly limited. A variety of synthesis methods generally used in the art can be used.

When a composite oxide in the film form is synthesized, the synthesis step can be carried out via the physical vapor deposition (PVD) method. If the step is carried out via the PVD method, a means generally used in the art such as molecular beam deposition, vacuum deposition, ion plating, or sputtering can be used with the use of Si, glass, Si/TiW, an electrochemical array, or a rotating disc electrode as a substrate. Preferably, molecular beam deposition is carried out. When molecular beam deposition is carried out, it is preferable to supply oxygen gas at a pressure of 1.0×10⁻⁶ to 5.0×10⁻⁵ Ton and an applied electric power of 300 to 600 W.

With the use of the above method, an amorphous composite oxide in a film form having a desired average film thickness can be synthesized.

### 3-2. Crystallization Step

A composite oxide in a film form prepared in the above synthesis step is normally in the amorphous state. Therefore, the purpose of the crystallization step is to heat-treat an amorphous composite oxide in a film form obtained in the synthesis step to cause crystallization, thereby preparing a crystalline composite oxide in a film form.

The step can be carried out by heat-treating a composite oxide obtained in the above synthesis step in an oxygen atmosphere. In this case, the annealing temperature for heat treatment is preferably at 500° C. to 800° C. and more preferably at 500° C. to 600° C. In addition, annealing time is preferably 2 to 10 hours and more preferably 6 hours.

A crystalline composite oxide can be obtained by carrying out the above step under the above conditions while it is in a film form and retains a desirable percentage of doped Sb without loss.

### 3-3. Catalyst Supporting Step

The purpose of this step is to allow an amorphous composite oxide obtained in the synthesis step or a crystalline composite oxide obtained in the crystallization step to support a catalyst so as to prepare an electrocatalyst.

This step can be carried out via the physical vapor deposition (PVD) method, as in the case of the above synthesis step. Preferably, molecular beam deposition is used. When molecular beam deposition is used, the maximum evaporation rate is preferably 1.0×10⁻² to 2.0×10⁻² nm s⁻¹. An electrocatalyst having a desired average particle size and supporting a catalyst thereon can be produced using the above method.

The highly stable electrocatalyst having excellent electrochemical properties of the present invention can be produced using the above production method.

### EXAMPLES

The present invention is hereinafter described in greater detail with reference to the following Examples and Comparative Examples.

### Example 1

### SnSbOₓ Support

### [Preparation of SnSbOₓ Supports]

Thin films of Sb-doped SnO₂ were prepared on a range of substrates (Si, glass, Si/TiW, electrochemical array and rotating disc electrodes) relevant to the measurements due to be obtained. Silicon substrates were used to deposit SnSb oxide (SnSbOₓ) films in order to perform complete 10×10 macros in EDX and XRD (when required) before and after crystallization as well as stability tests in acid before crystallization. Glass substrates were necessary in order to obtain conductivity measurements using a 4 point probe station, before and after crystallization of the SnSb oxide. Si/TiW substrates were necessary in order to measure the conductivity through the oxide film for both amorphous and crystalline samples. Electrochemical (E-chem) arrays were used to study the oxygen reduction reaction (ORR) of platinum particles deposited on the amorphous oxides, whilst rotating disc electrodes (RDE) substrates were used to study the ORR on Pt particles deposited on crystalline oxide films. Further RDE were used for stability experiments on amorphous oxide films.

The deposition of SnSbOₓ supports was carried out in a purpose built molecular beam epitaxy system modified for High Throughput Physical Vapour Deposition (HT-PVD) established by ILIKA Technologies LTD. Each of the substrates was coated with a layer of SnSbOₓ by introducing oxygen at a power of 400 W and a pressure of 5.0×10⁻⁵ Torr during Sn and Sb depositions with a graduated flux of Sn atom across the diagonal, or Sb atom across the horizontal of the substrate array. The graduated flux was controlled through the arrangement of the Knudsen cell sources of Sn and Sb and O source.

The atomic percentages of Sn and Sb in the thin films were determined by EDX analysis using a JSM 5910 scanning electron microscope. The atomic percentages of Sn and Sb in all the thin films were in the range of 75-100 at. % Sn and 25-0 at. % Sb.

X-ray diffraction of the oxide supports was obtained with a Bruker D8 diffractometer equipped with a GADDS detector operating at 40 kV and 20 mA. Scans were done at 3.4° min⁻¹ for 2θ values between 19° and 58° (total collection time of 10 minutes for each composition).

All samples deposited on silicon substrates were characterized by XRD. Generally, thin film formation by evaporation of tin oxide onto room temperature substrates leads to amorphous materials. The same observation was confirmed for the tin antimony oxides deposited. In fact, none of the deposited samples showed any XRD features (data not shown).

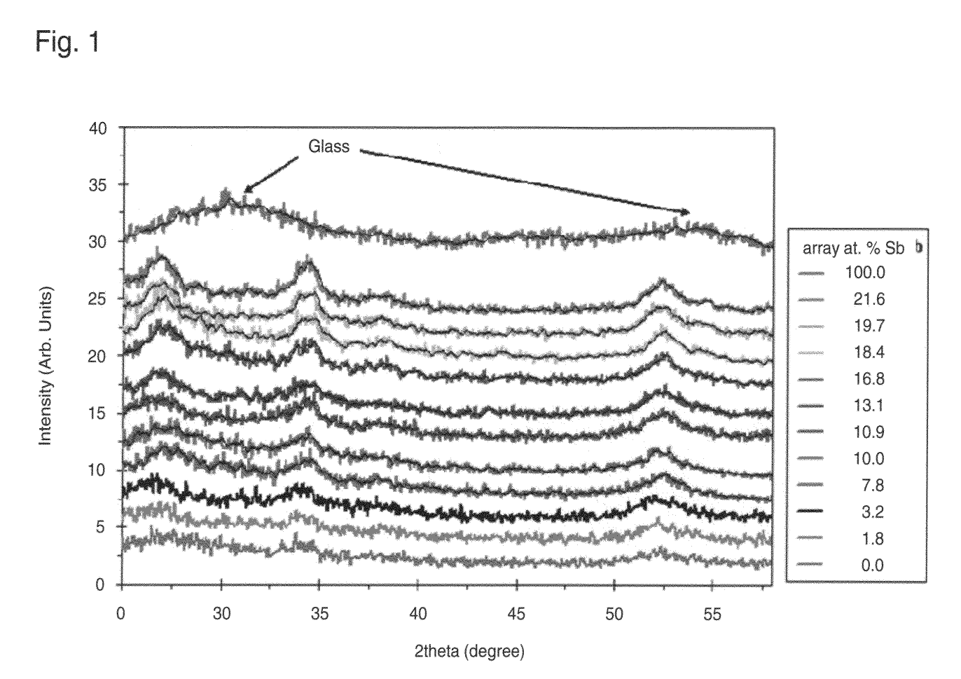

Several tests were performed in order to identify the best annealing conditions to obtain a crystalline structure of the tin antimony oxide without any compositional change. After 6 hours of annealing at 500° C. in an atmosphere of oxygen some broad peaks were observed. Further annealing for 6 hours at 600° C. in an atmosphere of oxygen produced no significant change in the spectra, whilst a loss of antimony was detected by EDX measurements. Hence it was decided that all the silicon substrates would be annealed at 500° C. for 6 hours in a furnace under an atmosphere of oxygen. FIG. 1 shows the spectra of pure SnOₓ and pure SbOₓ as well as the spectra of SnSbOₓ across the range of composition studied. All binary oxides and the pure SnOₓ were deposited on silicon substrates while the pure SbO_{X} was deposited on a glass substrate.

As shown in FIG. 1, some broad peaks derived from SnOₓ were observed, whereas no obvious crystallization of SbOₓ was seen. It is likely that SbOₓ was not annealed to high enough temperature to crystallize, however care has to be taken when drawing any conclusion as antimony oxide features could be hidden in the broad XRD peaks attributed to the glass substrate. These results suggest that SnSbOₓ supports annealed at 500° C. for 6 hours are in the crystal form.

From the XRD data obtained, crystallization conditions of 500° C. for 6 hours in an atmosphere of O₂ were used to prepare the crystalline oxide films subsequently used as RDE substrates.

### [Conductivity Measurements of SnSbOₓ Supports]

The resistivity of the deposited thin films was studied by four point probe (4PP) measurements. Measurements were taken on both the amorphous thin films and those crystallized at 500° C. for 6 hours in O₂. FIGS. 2 and 3 show the mean resistivity given versus the Sb at. %, for both the amorphous and crystalline films, respectively. The individual points show the averaged conductivity against the average composition for a single sample, whilst also included are the actual data points gathered (from the oxide film on a glass substrate) versus compositional measurements obtained by EDX on an equivalent Si sample.

The general trend from the data in FIG. 2 shows an initial decrease from the value obtained for the pure SnO₂ film, with a potential minimum at around 8-10 at. % Sb. Above 15 at. % Sb there is a quite sharp increase in the resistivity of the thin films.

For the films crystallized at 500° C., shown in FIG. 3, a similar trend is observed, however, the resistivity for the higher concentrations of Sb is considerably higher than for the amorphous samples, and the optimum conductivity appears to have been shifted to a slightly lower concentration of Sb (approx. 1-3 at. %).

### [Stability of SnSbOₓ Supports in Acid]

Stability tests have been carried out on amorphous stoichiometric SnSb oxides over the entire range of compositions of interest (0 to 25 at. % Sb). The silicon substrates were individually suspended in 200 mL of 0.1M H₂SO₄ at 80° C. for 24 h. Photos of each substrate were taken before and after the acid treatment and EDX measurements were also performed before, and after the acid treatment.

In order to determine if there was a gradual degradation of the film, as opposed to a poor adherence of the oxide film to the silicon substrate, photographs were taken of the substrates 2, 4 and 6 hours into the acid treatment.

It should be noted that the oxide films remained transparent across the entire compositional range as observed on the glass substrates, and that the only changes in colour observed were therefore attributed to the change in the thickness. The colours are not associated with any absorption in the visible region, material-induced by the antimony doping (i.e., k is assumed to be zero).

Using a spectroscopic ellipsometer the thickness of oxides deposited on glass substrates under similar depositions conditions was obtained. Most arrays showed a whitish-green color prior to acid treatment and this was found to correspond to a thickness of approximately 122 nm.

Using a colour fringes chart for thin oxide films, and assuming a refractive index of 2.90 (corresponding to a thickness of less than 122 nm for a whitish-green color of the oxide), a visual estimation of the thickness of each oxide film was performed at each step of the stability experiment. FIG. 4 shows thickness loss versus atomic percentage of Sb in the SnSb oxide for various acid exposure times. In FIG. 4, the thickness loss, calculated from the equation below, is plotted.

[Thickness (time 0)−Thickness (time i)]×100/Thickness (time 0)

With i being the time the substrate was left in the acid bath.

As shown in FIG. 4, the pure SnOₓ film was unstable in acid, and the doped oxide with an atomic percentage of Sb in the Sn matrix above 10 at. % (12.5 at. % or more) was also unstable. Only films with an atomic percentage of Sb between 2 and 10 at. % Sb were relatively stable after 24 hours.

### Example 2

### SnSbOₓ/Pt Electrocatalyst

### [Preparation of SnSbOₓ/Pt Electrocatalyst]

Platinum particles were deposited from an electron-gun source onto the oxide-covered substrates for electrochemical screening (electrochemical arrays and rotating disc electrodes). The maximal evaporation rate was 1.5×10⁻² nm s⁻¹, determined by a quartz microbalance and confirmed by deposition of thicker films and subsequent measurement with AFM and ellipsometry.

The Pt particles were characterized by Transmission Electron Microscopy (TEM) of films prepared using identical deposition conditions to those used with the oxide support, onto carbon TEM grids.

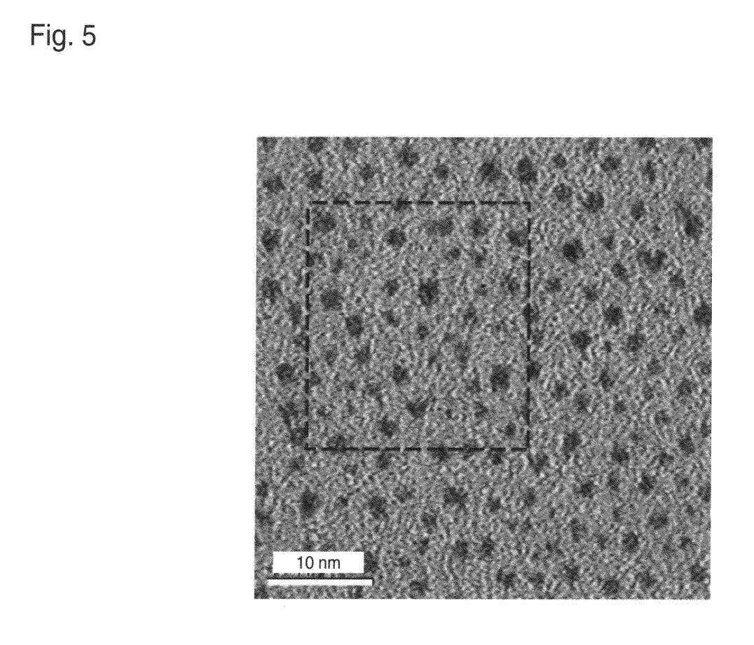

For each electrochemical array, which contains two different oxide compositions, two different particle sizes were deposited corresponding to deposition times of 1 and 2 minutes, respectively, on half of the array each. For the rotating disk electrodes, a deposition time of 1 minute was used for all samples. FIG. 5 shows typical TEM image.

The image analysis was performed using in-house software. It should be noted, however, that the particle sizes obtained on the different SnSbOₓ supports may differ slightly from those obtained on the standard TEM grids due to particle-support interactions.

As shown in FIG. 5, a deposition time of 1 minute provides a mean particle size of less than 2.0 nm whilst a higher deposition time of 2 minutes gives an average particle size of less than 2.4 nm.

### Example 3

### Electrochemical Screening of Amorphous SnSbOₓ/Pt

The electrochemical characterization and assessment of activity were carried out using cell hardware, instrumentation and software specifically developed for high throughput screening by ILIKA Technologies LTD. Details of the high throughput electrochemical screening protocol is shown in Table 1.

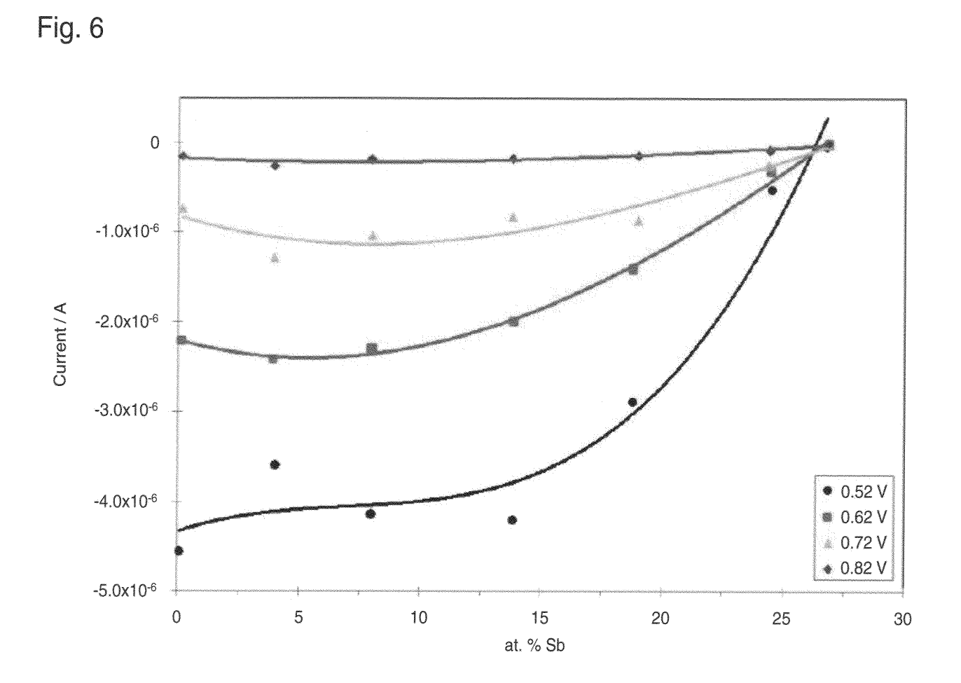

TABLE 1
Electrochemical screening procedure

| | | | Sweep | |
|---|---|---|---|---|
| | | Potential limits | rate | |
| Experiment | Gas | V vs SHE | mV s⁻¹ | Result |
| O₂ reduction | Bubbling O₂ | Step from | | FIG. 6 |
| steps | in solution | 0.500 to 1.000 and | | |
| | | back to initial | | |
| | | potential in | | |
| | | 0.050 increments | | |
| | | every 90 s | | |
| 2-3 CV's in O₂ | O₂ | 0.025-1.200 | 5 | FIG. 7 |
| saturated | above solution | | | |
| solution | | | | |
| 100 CV's | Passing Ar | 0.025-1.2 | 100 | FIG. 8 |
| stability | above solution | | | |
| testing | | | | |

The activity for oxygen reduction reaction (ORR) was assessed from steady-state currents observed during potential step experiments. Cyclic voltammograms in oxygen saturated electrolyte were also performed to assess the onset for oxygen reduction activity. All electrochemical experiments were carried out in 0.5 M HClO₄ at 25° C. in a thermostated electrochemical cell. Although a mercury/mercury sulphate reference electrode was used experimentally all the potentials in this report are quoted vs. SHE.

All oxide supports prepared on the electrochemical arrays were obtained using an atom source, hence the oxides are believed to be stoichiometric to near-stoichiometric. All the oxides studied were amorphous, as the substrate was unable to sustain heat treatment at the temperature required for crystallization of the SnSb oxide.

### [Activity and Specific Activity for ORR]

For the potential step experiments carried out to measure the activity for the ORR, the electrolyte (0.5 M HClO₄) was first saturated with O₂ for 10 min at 0.50 V. After saturation at 0.50 V, the potential was then stepped from 0.50 V to 1.00 V and back to the initial potential again in 50 mV increments at 90 s intervals, while recording the current. This protocol is of interest in order to compare the activity of the catalyst to well-known catalysts such as Pt supported on carbon. This potential of 0.50 V was selected according to the cyclic voltammetry of the alloys in deoxygenated solution and is within the oxide reduction region. This way, we can minimize the interference of any oxide with the oxygen reduction reaction (ORR) taking place on the catalyst surface.

FIG. 6 shows the activity of the SnSbOₓ/Pt for the 1 min Pt deposition obtained (2.0 nm particles) combining the data from all the electrochemical arrays studied, for ORR at 0.52, 0.62, 0.72 and 0.82 V vs. SHE. From 0 to 13.0 at. % Sb the ORR is relatively constant, then starts to decrease rapidly to reach a value near to 0.0 A around 25 at. % Sb.

### [Cycling in Oxygen Saturated Electrolyte]

FIG. 7 shows the variation in the onset (ignition) potential for the range of compositions used for the 1 minute Pt deposition time (2.0 nm particles). It can be seen that there is little shift in the onset potential across the range of support compositions investigated until above 20 at. % Sb. A discontinuity is then observed at approximately 12.5 at. % Sb. It should be noted that the data obtained above 12.5 at. % Sb (grey area in FIG. 7) should be considered with care as the films above this composition were observed to be very unstable under acidic condition (see FIG. 4). Consequently, preference is given to Pt particles supported on the amorphous SnSbOₓ with an atomic percentage of Sb in the range of 0 to 10% in the Sn matrix.

### [Stability Measurement]

Using amorphous oxide samples with Pt particles prepared on rotating disk electrodes (RDE), RDE experiments of 100 cycles from 0.025 to 1.200 V at 100 mV s⁻¹ were performed in deoxygenated 0.5 M HClO₄. The typical behaviour observed is shown in FIG. 8.

From this it is clear that there is considerable reduction in the total current obtained for the high Sb support. However, it was clearly observed that the support has corroded during the cycling experiments for the two higher Sb concentrations leading to a reduction in the total current density. Hence, it can be concluded that high concentrations of Sb provide instable amorphous supports.

### Example 4

### Electrochemical Screening of Crystalline SnSbOₓ/Pt

As it was not possible to crystallize the oxide supports on the electrochemical arrays, due to temperature limitations of the substrate, a range of rotating disk electrodes (base material Ti) were covered in the oxide substrate of the required composition and then crystallized at 500° C. for 6 hours in O₂.

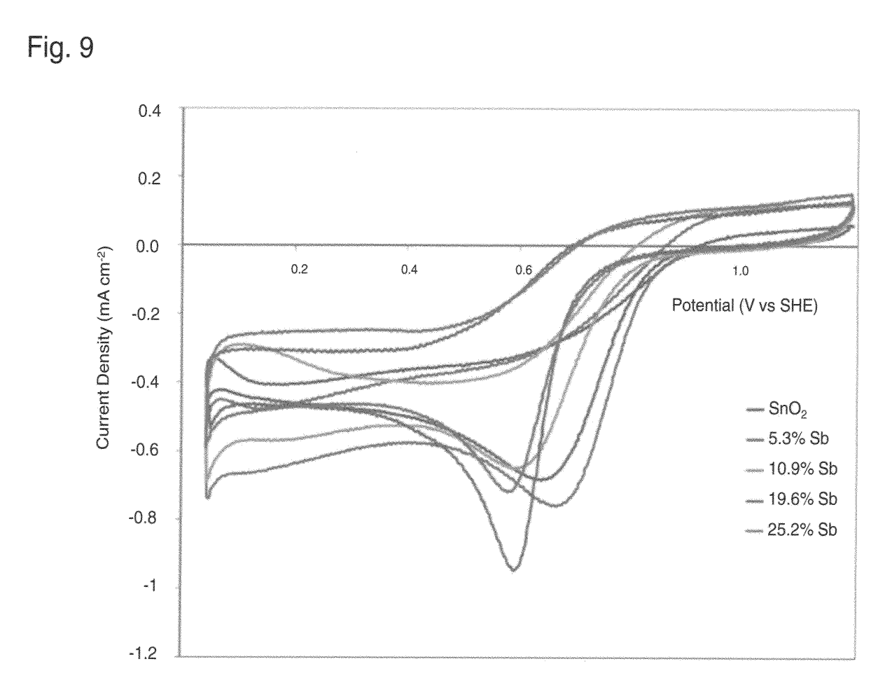

After crystallization Pt particles were deposited on the RDE electrodes for the desired particle size (˜2.0 nm, 1 min dose). Hence the current densities presented are specific current densities where the Pt surface area is calculated from the TEM data. FIG. 9 shows the first cycle for Pt particles (the 1 min dose required to give 2.0 nm particles on TEM grids) on a range of different crystalline supports in O₂ saturated 0.5M HClO₄ at 20 mV s⁻¹. All these samples were crystallized at 500° C. in O₂ for 6 hours (with the exception of the pure SnO₂ which was crystallized at 600° C. in for 6 hours). FIG. 10 shows the shift in the ignition potential for oxygen reduction with increasing Sb percentage in the SnSb oxide matrix.

It can be seen that there is a shift to lower potentials with increasing Sb, however this shift is not significant at low Sb concentrations. Preference is given to Pt particles supported on the crystalline SnSbOₓ with an atomic percentage of Sb in the range of 0 to 5% in the Sn matrix.

In order to make a comparison between the O₂ reduction characteristics on Pt particles supported on the amorphous and crystalline oxides; three electrodes of almost identical oxide composition were prepared under different conditions. The result is shown in FIG. 11.

It can be seen that on crystallizing the support, the oxygen reduction peak shifts to higher potentials. On increasing the crystallization temperature from 500 to 600° C. a further enhancement is observed, however, it has been observed that oxidation at this higher temperature can lead to a loss in antimony.

### INDUSTRIAL APPLICABILITY

As described above, according to the present invention, a highly stable electrocatalyst having excellent electrochemical properties, acid resistance, and durability to potential cycles applied for long time can be obtained. In addition, it becomes possible to produce fuel cells that exhibit stable power generation performance for long time with the use of the electrocatalyst of the present invention.

It is intended that all the publications, patents, and patent applications referred herein are incorporated herein as reference.

1. (canceled)

2. An electrocatalyst, comprising a support containing a crystalline composite oxide containing Sb-doped SnO₂ and a catalyst supported by the support, wherein the percentage of Sb with respect to the sum of Sb and Sn in the composite oxide is 1 to 3 at. %.

3. The electrocatalyst according to claim 2, wherein the catalyst is Pt.
